(19) United States
(12) Patent Application Publication
(10) Pub. No.: US 2020/0026379 A1
(43) Pub. Date: Jan. 23, 2020

(54) NEAR FIELD COMMUNICATION MANAGEMENT

(71) Applicant: LENOVO (Singapore) PTE. LTD., New Tech Park (SG)

(72) Inventors: Hideto Horikoshi, Yokohama-shi (JP); Masaki Oie, Yokohama-shi (JP)

(21) Appl. No.: 16/518,731

(22) Filed: Jul. 22, 2019

(30) Foreign Application Priority Data
Jul. 23, 2018 (JP) 2018-137486

(51) Int. Cl. G06F 3/044; H04B 5/00; G06K 9/00

(52) U.S. Cl. CPC G06F 3/044; G06K 9/0002; H04B 5/0043; H04B 5/0012

(57) ABSTRACT

An apparatus is provided to enable a close arrangement of a near-field communication device and a capacitive sensor that prevents interference of the capacitive sensor. The apparatus includes a first processing unit that executes first processing for detecting a detection target based on an output signal of a capacitive sensor. The apparatus also includes a second processing unit that executes second processing using radio by causing an alternating magnetic flux to be emitted from a coil connected to an electromagnetic coupling wireless module and arranged close to the capacitive sensor, wherein the second processing unit controls the operation of the second processing according to the operating state of the first processing.

### FIELD

The subject matter disclosed herein relates to information processing devices and more particularly relates to an improved system and method for the management of near field communication devices that are arranged close to a capacitive sensor.

### BACKGROUND

In Near-field communication (“NFC”), communication can be performed between coil antennas, via electromagnetic coupling, that are brought within about 2 to 4 centimeters of each other. For example, electronic devices with coil antennas may support NFC. However, in a laptop that supports NFC, a magnetic flux emitted from an NFC coil may create electromagnetic noise that causes the malfunction of other devices such as a touch pad or a fingerprint reader (“FPR”).

### SUMMARY

An apparatus is provided to enable a close arrangement of a near-field communication device and a capacitive sensor that prevents interference of the capacitive sensor. The apparatus includes a first processing unit that executes first processing for detecting a detection target based on an output signal of a capacitive sensor. The apparatus also includes a second processing unit that executes second processing using radio by causing an alternating magnetic flux to be emitted from a coil connected to an electromagnetic coupling wireless module and arranged close to the capacitive sensor, wherein the second processing unit controls the operation of the second processing according to the operating state of the first processing.

In certain embodiments, the second processing unit controls whether to emit the alternating magnetic flux from the coil according to the operating state of the first processing. Additionally, the second processing unit controls the alternating magnetic flux to be emitted from the coil in response to completion of the first processing.

In certain embodiments, the second processing unit controls the alternating magnetic flux not to be emitted from the coil when the first processing is started, and the first processing unit starts the first processing after the second processing unit controls the alternating magnetic flux not to be emitted from the coil. In some embodiments, the first processing unit stops the first processing when the started first processing is not completed for more than a predetermined time, and the second processing unit controls the alternating magnetic flux to be emitted from the coil when the first processing is not completed for more than the predetermined time.

In certain embodiments, the first processing unit and the second processing unit execute the first processing and the second processing alternately under a predetermined condition. The capacitive sensor, in some embodiments, is a fingerprint sensor for detecting a fingerprint, and the first processing unit performs fingerprint authentication by detecting the fingerprint based on an output signal of the fingerprint sensor. In certain embodiments the capacitive sensor and the coil are arranged in positions corresponding to an opening without being covered with metal in a chassis of the electronic device.

A corresponding method is provided to implement the features of the apparatus.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic diagram for describing the principle of a capacitive fingerprint sensor;

FIG. 2 is a diagram illustrating an example of an electronic device according to embodiments of the present disclosure;

FIG. 3 is a schematic diagram illustrating the arrangement of the fingerprint sensor and an NFC coil according to embodiments of the present disclosure;

FIG. 4 is a diagram for describing a state where the NFC coil provided in the electronic device and an NFC coil provided in an NFC card are electromagnetically coupled to each other according to embodiments of the present disclosure;

FIG. 5 is a diagram illustrating a brief overview of control according to embodiments of the present disclosure;

FIG. 6 is a top view of an FPR module according to embodiments of the N present disclosure;

FIG. 7 is a cross-sectional view of the FPR module according to embodiments of the present disclosure;

FIG. 8 is a top view illustrating a state where a top sheet and a resin frame of the FPR module are removed according to embodiments of the present disclosure;

FIG. 9 is a top view illustrating a state where an FPC of the FPR module is further removed according to embodiments of the present disclosure;

FIG. 10 is a block diagram illustrating an example of the configuration of the electronic device according to embodiments of the present disclosure;

FIG. 11 is a chart illustrating an example of the emission timing of a magnetic flux in wireless communication processing according to embodiments of the present disclosure;

FIG. 12 is a chart illustrating an example of fingerprint detection timing in fingerprint authentication processing according to embodiments of the present disclosure;

FIG. 13 is a chart illustrating an example of the control timing of wireless communication processing according to an operating state of the fingerprint authentication processing according to embodiments of the present disclosure;

FIG. 14 is a flowchart illustrating an example of processing according to embodiments of the present disclosure;

FIG. 15 is a flowchart illustrating an example of processing according to embodiments of the present disclosure; and

FIG. 16 is a flowchart illustrating an example of processing according to embodiments of the present disclosure.

### DETAILED DESCRIPTION

Embodiments of the present disclosure will be described in detail below with reference to the accompanying drawings. Note that the same portions are given the same reference numerals in respectively drawings.

The various configurations of an electronic device that supports electromagnetic coupling wireless communication and fingerprint authentication using a capacitive sensor will be described below.

In most wireless communication, energy emitted by a transmitting antenna propagates through space in the form of electromagnetic waves, and a receiving antenna absorbs energy from the electromagnetic waves in the space. When an alternating voltage is applied to the transmitting antenna, a high-frequency current flows to generate an electric field and a magnetic field (electromagnetic field) around the antenna. The electromagnetic waves used in wireless communication are so generated that the electric field and the magnetic field will be mutually chained to propagate a long distance. Data can be transmitted by modulating the electromagnetic waves serving as carrier waves with a baseband signal.

On the other hand, when an alternating current is caused to flow through a transmitting coil, an alternating magnetic field is generated in space near the transmitting coil. The alternating magnetic field generates an alternating magnetic flux with a magnitude according to the magnetic permeability of the space, and voltage is induced by electromagnetic induction in a receiving coil interlinked to the alternating magnetic flux. This phenomenon is called electromagnetic induction or electromagnetic coupling, which can be used in wireless communication. When the alternating current flows through the transmitting coil, the transmitting coil also emits electromagnetic waves. However, a system of performing communication using the electromagnetic coupling of coils brought close to each other is called electromagnetic coupling wireless communication in distinction from a communication system using electromagnetic waves.

Electromagnetic coupling wireless communication is employed in near-field communication (“NFC”), radio frequency identifier (“RFID”), Felica®, and the like. Electromagnetic coupling wireless communication is also employed in wireless electric power transmission. In the electromagnetic coupling wireless communication, since carrier waves serve as an alternating magnetic flux and the communication distance falls with the range of a near magnetic field in which the electromagnetic coupling is enabled, the communication distance is short. In the electromagnetic coupling wireless communication, a large amount of alternating magnetic flux is generated near the transmitting coil. Therefore, when a wireless module is mounted in the electronic device, the wireless module is likely to be a noise source.

In NFC, passive communication in which communication is performed with a non-contact IC card (hereinafter called the “NFC card”) including a reader/writer having no power supply, and active communication in which two devices each having a power supply alternately serve as an initiator and a target to perform communication are defined. In the passive communication, a polling device operating as the initiator emits a strong alternating magnetic flux to supply energy to a listening device as the target.

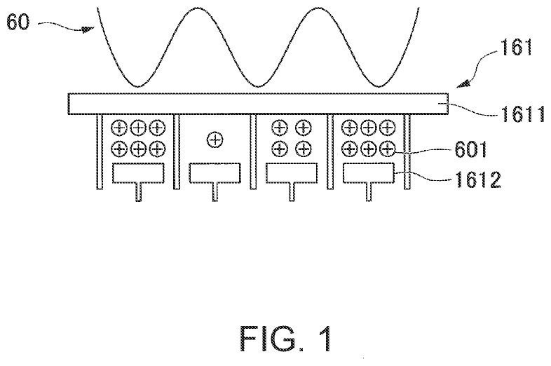

FIG. 1 is a schematic diagram for describing the principle of a capacitive fingerprint sensor in accordance with embodiments of the present disclosure. This figure represents the cross-section of a fingerprint sensor 161 (which, as will be described below, is part of a fingerprint reader or “FPR”). In the fingerprint sensor 161, multiple electrodes 1612 are arranged in the form of a matrix below a protective film 1611 provided on a top face (In the illustrated example, multiple electrodes are arranged in the lateral direction, but multiple electrodes are also arranged in the depth direction). Because of the unevenness (see reference numeral 60) of the fingerprint of a finger with which the fingerprint sensor 161 is touched, more electric charges 601 are accumulated in electrodes below protruding portions directly touching the protective film 1611 than in electrodes below recessed portions which do not directly touch the protective film 1611. Using the differences in way of accumulation of electric charges 601 due to the unevenness of this fingerprint, the fingerprint can be detected. For example, the FPR can detect and register the fingerprint of a user in advance to match a fingerprint detected later with the registered fingerprint so as to perform fingerprint authentication in order to identify the user.

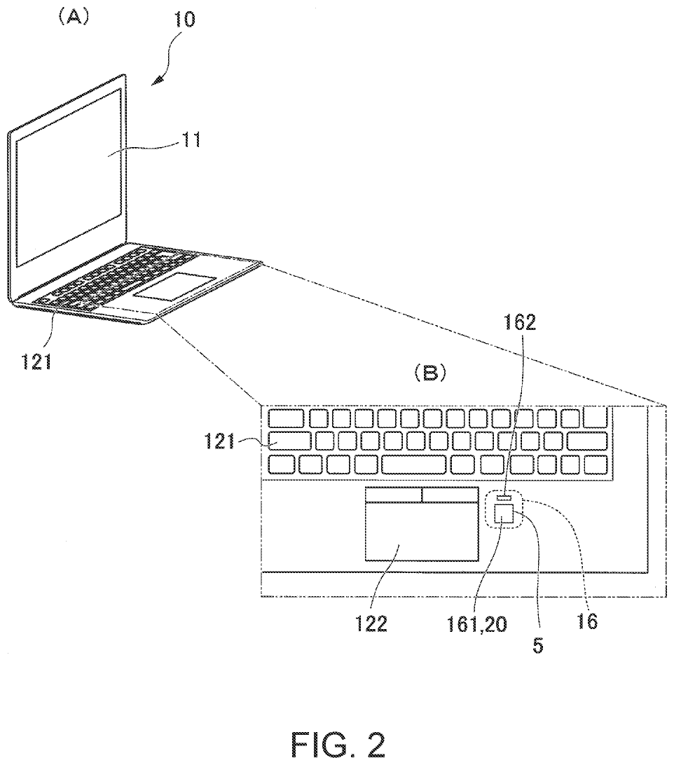

FIG. 2 is a diagram illustrating an example of the electronic device according to embodiments of the present disclosure. An example of an electronic device 10 includes a laptop personal computer (PC) that supports NFC passive communication as the electromagnetic coupling wireless communication and FPR using a capacitive sensor. In FIG. 2, (A) is a perspective view of the overall appearance of the electronic device 10, and (B) is an enlarged view of a section surrounded by a broken line at (A). The electronic device 10 includes a display unit 11, a keyboard 121, and a touch pad 122. The electronic device 10 is covered with a chassis partially or wholly made by using a metallic member, and an opening 5 is provided in a space on the right side of the touch pad 122. The opening 5 is an area without being covered with the metallic member, which is, for example, a hole provided in the chassis. Note that the opening 5 may also be an area using a non-conductive member (a resin member or the like).

The opening 5 is a hole provided to detect the fingerprint of a finger of the user, and an FPR module 16 is placed in a location corresponding to this hole. In the FPR module 16, the capacitive fingerprint sensor 161, a guiding LED 162 for urging the user to perform fingerprint authentication, and an NFC coil 20 as NFC transmitting coil are arranged. The fingerprint sensor 161 is arranged within the opening 5 to detect the fingerprint of the finger with which this opening 5 is touched. The NFC coil 20 is also arranged within the opening 5 not to obstruct a magnetic flux emitted. Thus, since the hole for the fingerprint sensor 161 is shared as a hole for the NFC coil 20, there is no need to make another hole for the NFC coil 20 in the chassis of the electronic device 10 and this can also contribute to space saving.

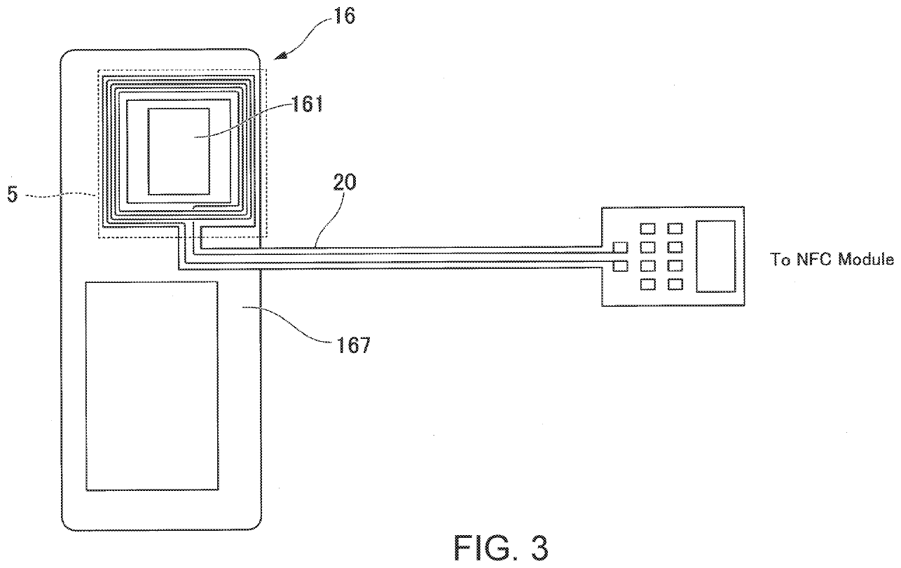

FIG. 3 is a schematic diagram illustrating the arrangement of the fingerprint sensor 161 and the NFC coil 20 in the FPR module 16 according embodiments of the present disclosure. In the FPR module 16, the fingerprint sensor 161 and the NFC coil 20 are arranged close to each other on a PCB (Printed Circuit Board) 167. Being arranged close to each other means that they are placed a short distance from each other in such an extent that the magnetic flux emitted from the NFC coil 20 affects the fingerprint sensor 161. In the illustrated example, the NFC coil 20 is wired to surround the periphery of the fingerprint sensor 161. For example, the NFC coil 20 is formed on an FPC (Flexible Printed Circuit), and the tip thereof is connected to an NFC module to perform communication processing using the NFC coil 20. An opening 5 indicated by a broken line is the opening 5 of the electronic device 10 illustrated at (B) in FIG. 2, which is illustrated to indicate the positional relation when the FPR module 16 is embedded in the electronic device 10. As illustrated in FIG. 3, the fingerprint sensor 161 and the coil winding section of the NFC coil 20 are arranged to fit inside of the hole (opening area) of the opening 5.

In the illustrated example, the whole of the coil winding section of the NFC coil 20 is placed to fit inside of the hole (opening area) of the opening 5, but at least part thereof may be placed to fit inside of the hole. Further, in the illustrated example, the NFC coil 20 is formed on the FPC, but it may be formed on the PCB 167. The details of the structure of the FPR module 16 according to the embodiment will be described later.

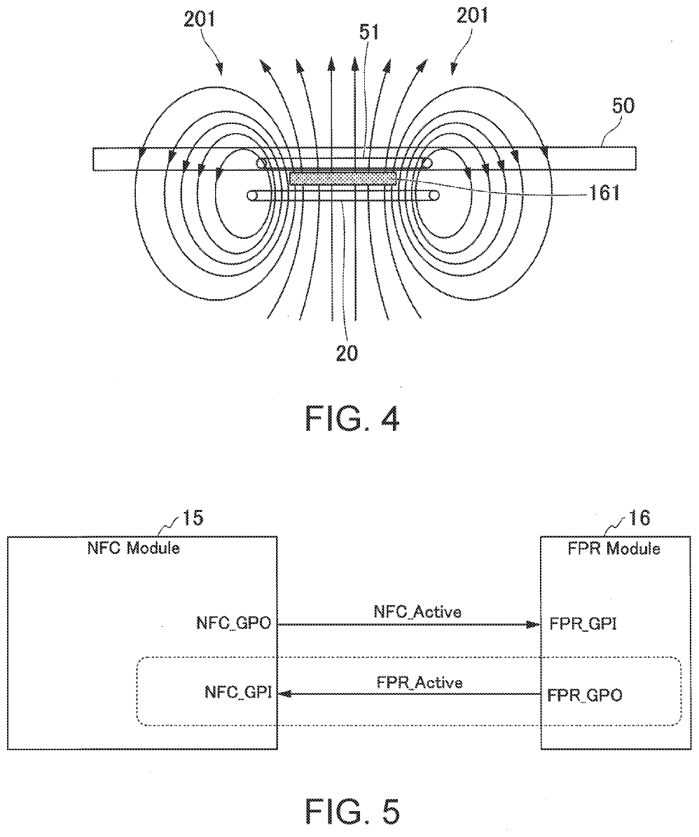

FIG. 4 is a diagram for describing a state where the NFC coil 20 provided in the electronic device 10 and an NFC coil 51 provided in an NFC card 50 are electromagnetically coupled to each other in accordance with embodiments of the present disclosure. In the NFC, a frequency band of 13.56 MHz is used. When a high-frequency current in the used frequency band flows through the NFC coil 20, an alternating magnetic field is generated therearound to cause a 13.56 MHz alternating magnetic flux 201 to flow in the form of carrier waves from one side to the other side of the opening of the coil. When the NFC coil 51 comes close to a position where the NFC coil 51 is interlinked to the alternating magnetic flux 201, an induced voltage is generated. The alternating magnetic flux 201 also induces a voltage in metal present around the NFC coil 20, which causes noise for each device. Since part of the alternating magnetic flux 201 flows through the fingerprint sensor 161, noise is also generated in the fingerprint sensor 161. Therefore, when a magnetic flux is emitted from the NFC coil 20 during detection of the fingerprint, there is a concern that electric charges will be accumulated in the fingerprint sensor 161 under the influence of the alternating magnetic flux 201 to cause a malfunction. For example, when electric charges are accumulated in the fingerprint sensor 161 under the influence of the alternating magnetic flux 201, there is a possibility of such a false detection that the finger touched regardless of no finger touched.

Therefore, the electronic device 10 according to the embodiment controls the operation of wireless communication processing by the NFC according to the operating state of fingerprint authentication processing by the FPR. Specifically, according to the operating state of the fingerprint authentication processing by the FPR, the electronic device 10 controls whether to emit an alternating magnetic flux from the NFC coil 20. FIG. 5 is a diagram illustrating a brief overview of control according to the embodiment. The FPR module 16 outputs, to the NFC module 15, an FPR active signal (FPR_Active) indicating whether the operating state of the fingerprint authentication processing by the FPR is “active” or not. When the FPR active signal (FPR_Active) output from the FPR module 16 is “active,” the NFC module 15 prohibits output of radio waves (NFC_Radio) so as not to emit the magnetic flux from the NFC coil 20. On the other hand, when the FPR active signal (FPR_Active) output from the FPR module 16 is “inactive,” the NFC module 15 allows output of the radio waves (NFC_Radio) so as to emit the magnetic flux from the NFC coil 20. Thus, since the electronic device 10 is not affected by the NFC coil 20 during the operation of the fingerprint authentication processing by the FPR, any malfunction (false detection) by the fingerprint sensor 161 cannot occur.

Further, the NFC module 15 may output, to the FPR module 16, an NFC active signal (NFC_Active) indicating whether the operating state of the wireless communication processing is “active” (during communication) or not. Then, when the NFC active signal (NFC_Active) output from the NFC module 15 is “active,” the FPR module 16 may control not to execute the fingerprint authentication processing by the FPR. On the other hand, when the NFC active signal (NFC_Active) output from the NFC module 15 is “inactive,” the FPR module 16 executes the fingerprint authentication processing by the FPR. Thus, while the NFC wireless communication is already being performed, since the electronic device 10 places a priority on processing during communication without executing the fingerprint authentication processing by the FPR, any malfunction (false detection) by the fingerprint sensor 161 cannot occur.

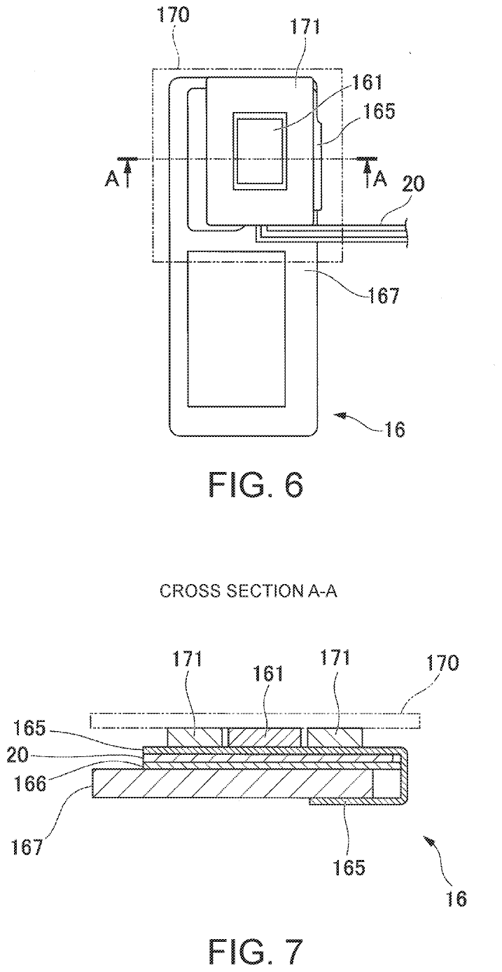

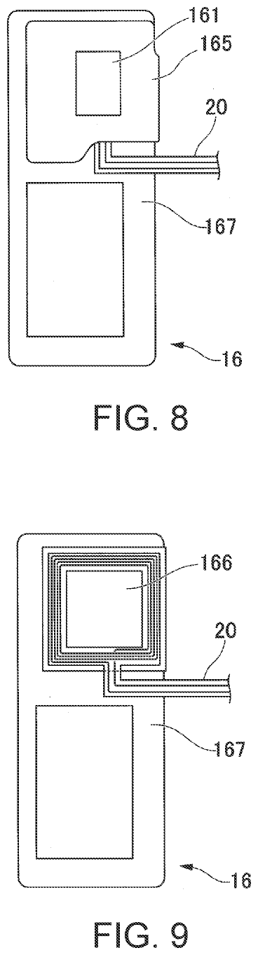

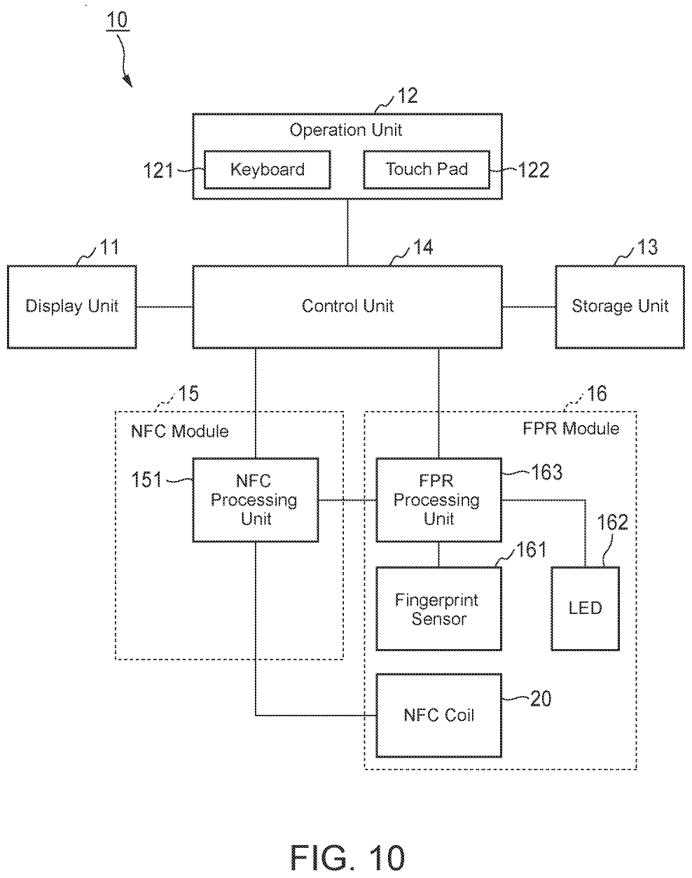

Referring next to FIG. 6 to FIG. 9, an example of the structure of the FPR module 16 will be described. FIG. 6 is a top view of the FPR module 16. FIG. 7 is a cross-sectional view of the FPR module 16. The FPR module 16 is constructed such that parts (members) are arranged hierarchically on the PCB 167. A ferrite sheet 166, the NFC coil 20, an FPC 165 with the fingerprint sensor 161 mounted thereon, a resin frame 171, and a top sheet 17 are arranged in this order from the lower layer toward the upper layer. In the top view of FIG. 6, the periphery of the top sheet 170 is indicated by the broken line for convenience sake so that the parts (members) below the top sheet 170 can be seen. FIG. 8 is a top view illustrating a state where the top sheet 170 and the resin frame 171 of the FPR module 16 are removed. FIG. 9 is a top view illustrating a state where the FPC 165 is further removed from the state illustrated in FIG. 8.

The ferrite sheet 166 is laid on the PCB 167 to increase the magnetic flux emitted from the NFC coil 20, and the NFC coil 20 (FPC with the coil formed) is overlaid thereon (see FIG. 7 and FIG. 9). Further, the FPC 165 with the fingerprint sensor 161 mounted thereon is overlaid on the NFC coil 20 (see FIG. 7 and FIG. 8). Here, the fingerprint sensor 161 has such a positional relationship that the fingerprint sensor 161 is positioned near the coil center of the NFC coil 20. In other words, the NFC coil 20 is arranged as the layer just below the FPC 165 with the fingerprint sensor 161 mounted thereon to surround the periphery of the fingerprint sensor 161 when the FPR module 16 is viewed from the top. The FPC 165 goes around from the side to the bottom of the PCB 167 and is pressure-bonded to the bottom of the PCB 167. Note that a processing circuit for performing fingerprint authentication processing using the fingerprint sensor 161, parts, and the like are formed or mounted on the bottom of the PCB 167.

The resin frame 171 is a resin member having a thickness nearly equal to the thickness of the fingerprint sensor 161 in the height direction, and formed into a rectangular shape having, substantially at the center thereof, a rectangular hole larger than the area of the fingerprint sensor 161. The resin frame 171 is overlaid on the FPC 165 to fit (put) the fingerprint sensor 161 into the hole (see FIG. 6 and FIG. 7). This resin frame 171 is provided to overlay the top sheet 170 thereon, serving as a spacer to create space around the fingerprint sensor 161. In the absence of this resin frame 171, the surroundings of the fingerprint sensor 161 become unstable when the top sheet 170 are overlaid thereon. The top sheet 170 is a sheet-like member made of hard mylar or glass and provided as the uppermost layer of the FPR module 16 (see FIG. 6 and FIG. 7). In a state where the FPR module 16 is embedded in the electronic device 10, this top sheet 170 is exposed to the opening 5 (see FIG. 2) as a surface touched with the finger of the user who performs fingerprint authentication.

The above-described structural example of the FPR module 16 is just one example, and the present disclosure is not limited thereto. Although the example of overlaying, on the NFC coil 20, the FPC 165 with the fingerprint sensor 161 mounted thereon is described, the NFC coil 20 may be overlaid on the FPC 165 with the fingerprint sensor 161 mounted thereon. In other words, the NFC coil 20 may be arranged to surround the fingerprint sensor 161 on the FPC 165 with the fingerprint sensor 161 mounted thereon. Further, the FPC 165 with the fingerprint sensor 161 mounted thereon and the NFC coil 20 may be integrally constructed. For example, a wiring pattern of the NFC coil may be formed on the FPC 165 with the fingerprint sensor 161 mounted thereon.

Further, although the example of arranging the NFC coil 20 to surround the fingerprint sensor 161 is described, at least part of the NFC coil 20 may be overlapped with the fingerprint sensor 161. Further, the top sheet 170 and the resin frame 171 may be pre-equipped (for example, bonded) as components of the FPR module 16, or may be prepared as parts different from the FPR module 16 and incorporated together with the FPR module 16 when the FPR module 16 is embedded into the electronic device 10. Further, when the opening 5 of the chassis of the electronic device 10 is covered with a resin member or the like beforehand, the top sheet 170 may be omitted.

FIG. 10 is a block diagram illustrating an example of the configuration of the electronic device 10 according to the embodiment. The illustrated electronic device 10 includes the display unit 11, an operation unit 12, a storage unit 13, a control unit 14, the NFC module 15, and the FPR module 16.

The display unit 11 is a display for displaying information such as images and text, which is configured to include a liquid crystal display panel, an organic EL (Electroluminescence) display panel, or the like.

The operation unit 12 is an operation input device configured to include the keyboard 121, the touch pad 122, and the like to accept user's operation input and output an operation signal based on the accepted operation input. Note that the operation unit 12 may be configured integrally with the display (e.g., display unit 11) as a touch panel or may be an external connection device such as a mouse.

The storage unit 13 includes, for example, an HDD (Hard Disk Drive) or an SSD (Solid State Drive), an EEPROM (Electrically Erasable Programmable Read-Only Memory), a ROM (Read-Only Memory), a RAM (Random Access Memory), and the like to store various pieces of information and images processed by the electronic device 10, and programs and the like. Note that the storage unit 13 is not limited to a storage unit incorporated in the electronic device 10, and it may be an external storage device connected through a digital input/output port or the like such as USB.

The control unit 14 includes a CPU (Central Processing Unit) and the like to execute processes by an OS (Operating System) and processes of various applications based on the OS and various application programs stored in the storage unit 13.

The NFC module 15 serves as an initiator to enable passive communication with the NFC card 50 as a target. For example, the NFC module 15 includes an NFC processing unit 151 to execute wireless communication processing by using the NFC coil 20 as an antenna and causing the NFC coil 20 to emit an alternating magnetic flux.

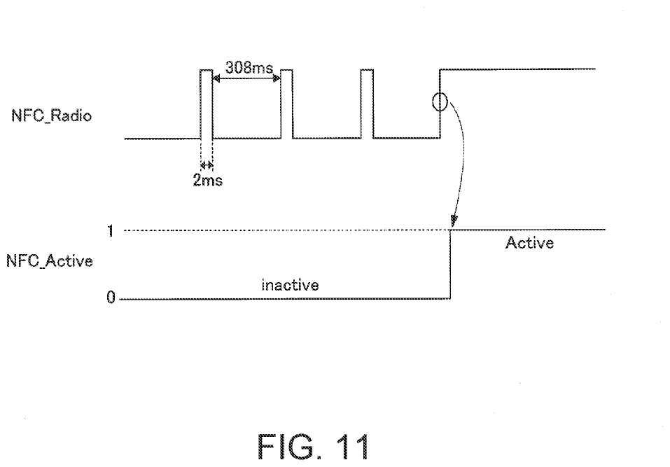

FIG. 11 is a chart illustrating an example of the emission timing of a magnetic flux in the wireless communication processing. In this figure, “NFC_Radio” indicates the emission timing of an alternating magnetic flux (output timing of radio waves). Further, “NFC_Active” indicates an NFC active signal indicative of the operating state of the wireless communication processing as described above.

For example, when the power supply is turned on, the NFC processing unit 151 causes the NFC coil 20 to emit an alternating magnetic flux intermittently at predetermined timings. In the illustrated example, the NFC processing unit 151 causes the alternating magnetic flux to be emitted for 2 ms (msec) at intervals of 308 ms (msec).

Each period during which the alternating magnetic flux is emitted intermittently at this predetermined timing is a period of a standby mode in which wireless communication with the NFC card 50 is not performed. The NFC processing unit 151 emits the alternating magnetic flux intermittently to detect the approach of the NFC card 50. When detecting the approach of the NFC card 50, the NFC processing unit 151 starts wireless communication with the NFC card 50. The NFC processing unit 151 causes the alternating magnetic flux to be emitted continuously during a period in which the wireless communication with the NFC card 50 is being performed.

Further, the NFC processing unit 151 controls the NFC active signal (NFC_Active) to be set to “0” (inactive) during a period in which the approach of the NFC card 50 is being detected by emitting the alternating magnetic flux intermittently. Further, in response to the start of the wireless communication as a result of detecting the approach of the NFC card 50, the NFC processing unit 151 controls the NFC active signal (NFC_Active) to be set from “0” (inactive) to “1” (active). Further, when the wireless communication with the NFC card 50 is terminated, the NFC processing unit 151 returns the NFC active signal (NFC_Active) from “1” (active) to “0” (inactive). Note that the NFC processing unit 151 may output the NFC active signal (NFC_Active) to the FPR processing unit 163.

Returning to FIG. 10, the FPR module 16 includes the fingerprint sensor 161, the LED 162, and an FPR processing unit 163. Note that the NFC coil 20 is included in the FPR module 16 structurally (see FIG. 6 to FIG. 9) but not included in the FPR module 16 functionally. The FPR processing unit 163 executes fingerprint authentication processing for detecting the fingerprint of a finger to be detected based on an output signal of the fingerprint sensor 161 and matching the detected fingerprint with a pre-registered fingerprint to execute fingerprint authentication.

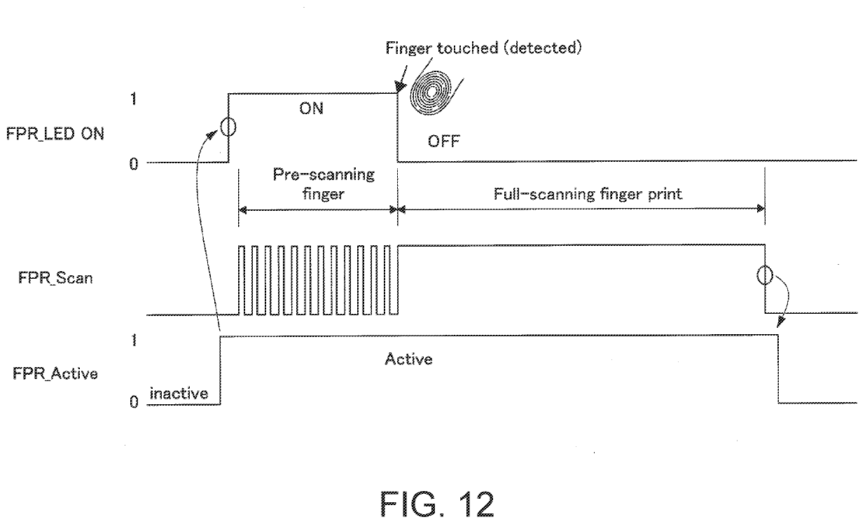

FIG. 12 is a chart illustrating an example of fingerprint detection timing in the fingerprint authentication processing. In this figure, “FPR_LED ON” indicates the control timing of putting the guiding LED 162 on. Further, “FPR_Scan” indicates detection timing by the fingerprint sensor 161. Further, as described above, “FPR_Active” indicates the FPR active signal indicative of the operating state of the fingerprint authentication processing.

When receiving an instruction to start the fingerprint authentication processing from the control unit 14 under the control of the OS, the FPR processing unit 163 controls the FPR active signal (FPR_Active) to be set from “0” (inactive) to “1” (active). Then, in response to the rise of the FPR active signal (FPR_Active), the FPR processing unit 163 controls the LED 162 to be turned ON (FPR_LED ON=“1”) so as to light up. Further, the FPR processing unit 163 starts pre-scanning (Pre-scanning finger) to detect the touch of the finger (touch on the opening 5). Next, when detecting the touch of the finger, the FPR processing unit 163 moves the processing to full-scanning (Full-scanning fingerprint) for reading the fingerprint. At this time, the FPR processing unit 163 controls the LED 162 to be turned OFF (FPR_LED ON=“0”) so as to turn off the light. Then, when the full scanning for reading the fingerprint is completed, the FPR processing unit 163 controls the FPR active signal (FPR_Active) to be set from “1” (active) to “0” (inactive).

The FPR processing unit 163 outputs this FPR active signal (FPR_Active) to the NFC processing unit 151. Based on the input FPR active signal, the NFC processing unit 151 controls the operation of the wireless communication processing according to the operating state of the fingerprint authentication processing. For example, the NFC processing unit 151 controls whether to emit the alternating magnetic flux from the NFC coil 20 according to the operating state of the fingerprint authentication processing. For example, the NFC processing unit 151 controls the alternating magnetic flux not to be emitted from the NFC coil 20 at the start of the fingerprint authentication processing. Then, after the NFC processing unit 151 controls the alternating magnetic flux not to be emitted from the NFC coil 20, the FPR processing unit 163 starts the fingerprint authentication processing. Further, the NFC processing unit 151 controls the alternating magnetic flux to be emitted from the NFC coil 20 in response to the completion of the fingerprint authentication processing.

Note that the control of the wireless communication processing according to the operating state of this fingerprint authentication processing is enabled only at a time other than during communication with the NFC card 50 (that is, only when the NFC active signal (NFC_Active) is “0” (inactive)). During communication with the NFC card 50, the communication is continued preferentially, and the control may be enabled after the completion of the communication.

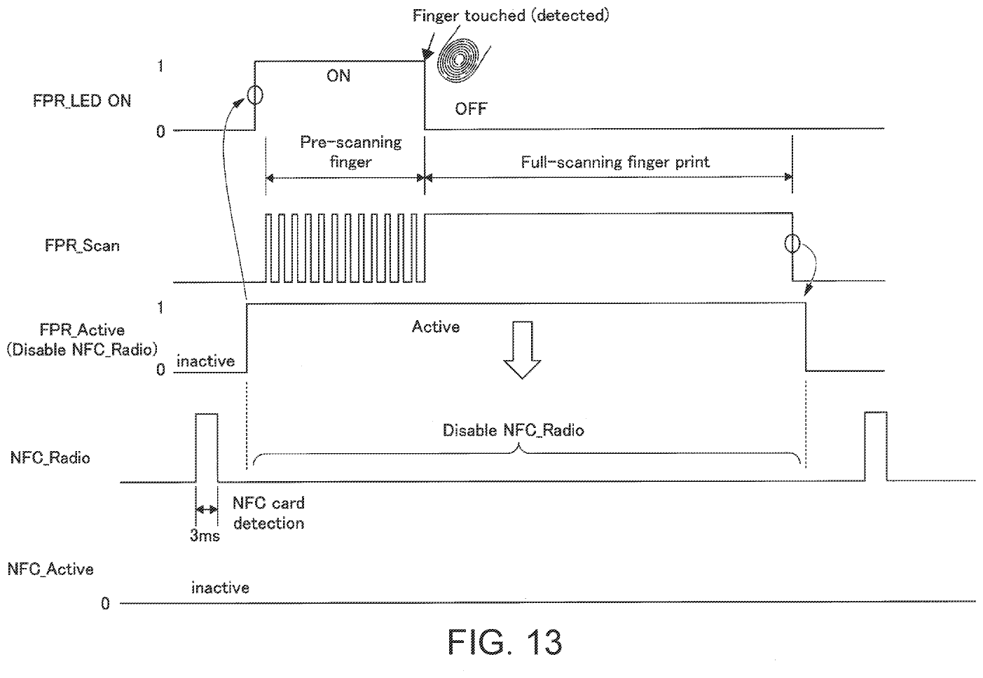

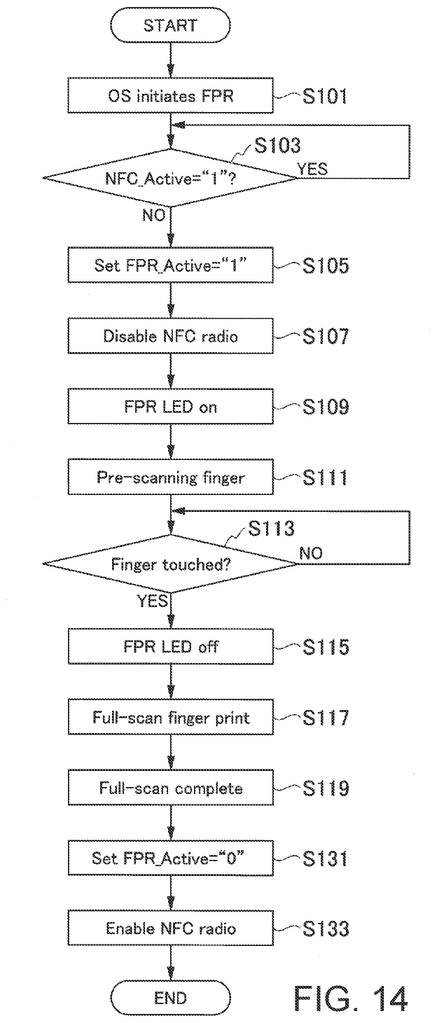

FIG. 13 is a chart illustrating an example of the control timing of the wireless communication processing according to the operating state of the fingerprint authentication processing. As illustrated, the FPR active signal (FPR_Active) also serves as a Disable signal for emission of the alternating magnetic flux (for “NFC_Radio” as output of radio waves). The NFC processing unit 151 controls “NFC_Radio” to be set to Disable so as not to emit the alternating magnetic flux from the NFC coil 20 during a period when the FPR active signal (FPR_Active) is “1” (active). On the other hand, the NFC processing unit 151 controls “NFC_Radio” to be set to Enable so as to emit the alternating magnetic flux from the NFC coil 20 during a period when the FPR active signal (FPR_Active) is “0” (inactive).

Thus, since the electronic device 10 inhibits the emission of the alternating magnetic flux from the NFC coil 20 at the timing when the fingerprint authentication processing is performed, malfunction (false detection) by the fingerprint sensor 161 can be prevented, and hence the fingerprint authentication processing can be performed properly.

Referring next to FIG. 14, the operation of processing in which the electronic device 10 controls the wireless communication processing according to the operating state of the fingerprint authentication processing will be described. FIG. 14 is a flowchart illustrating an example of processing according to the embodiment.

(Step S101) The control unit 14 instructs the FPR processing unit 163 to initiate the fingerprint authentication processing by the FPR under the control of the OS. Then, the procedure proceeds to processing in step S103.

(Step S103) The FPR processing unit 163 determines whether the NFC active signal (NFC_Active) output from the NFC processing unit 151 is “1” (active) or not. When determining that the NFC active signal (NFC_Active) is “1” (active) (YES), the FPR processing unit 163 proceeds to processing in step S105, while when determining that it is “0” (inactive) (NO), the FPR processing unit 163 performs the processing in step S103 again.

(Step S105) The FPR processing unit 163 sets the FPR active signal (FPR_Active) to “1” (active), and proceeds to processing in step S107.

(Step S107) In response to the fact that the FPR active signal (FPR_Active) is set to “1” (active), the NFC processing unit 151 controls “NFC_Radio” to be set to Disable so as not to emit the alternating magnetic flux from the NFC coil 20. Then, the procedure proceeds to processing in step S109.

(Step S109) The FPR processing unit 163 controls the LED 162 to be turned ON (FPR_LED ON=“1”) so as to light up, and proceeds to processing in step S111.

(Step S111) The FPR processing unit 163 starts pre-scanning (Pre-scanning finger) to detect the touch of the finger (touch on the opening 5). Then, the procedure proceeds to processing in step S113.

(Step S113) Based on the output of the fingerprint sensor 161, the FPR processing unit 163 determines whether the touch of the finger is detected or not. When the touch of the finger is detected (YES), the FPR processing unit 163 proceeds to processing in step S115, while when the touch of the finger is not detected (NO), the FPR processing unit 163 performs the processing in step S113 again.

(Step S115) The FPR processing unit 163 controls the LED 162 to be turned OFF (FPR_LED ON=“0”) so as to turn off the light, and proceeds to processing in step S117.

(Step S117) The FPR processing unit 163 makes a transition to full-scanning to read the fingerprint (Full-scanning fingerprint). Then, the procedure proceeds to processing in step S119.

(Step S119) Upon completion of full-scanning to read the fingerprint (Full-scanning fingerprint), the FPR processing unit 163 proceeds to processing in step S131.

(Step S131) The FPR processing unit 163 sets the FPR active signal (FPR_Active) to “0” (inactive), and proceeds to processing in step S133.

(Step S133) In response to the fact that the FPR active signal (FPR_Active) is set to “0” (inactive), the NFC processing unit 151 controls “NFC_Radio” to be set to Enable so as to emit the alternating magnetic flux from the NFC coil 20. Thus, the NFC processing unit 151 causes the alternating magnetic flux to be emitted from the NFC coil 20 intermittently so as to detect the approach of the NFC card.

As described above, the electronic device 10 according to the embodiment includes the FPR processing unit 163 (an example of a first processing unit) and the NFC processing unit 151 (an example of a second processing unit). Based on an output signal of the fingerprint sensor 161 (an example of a capacitive sensor), the FPR processing unit 163 executes fingerprint authentication processing (an example of first processing) for detecting the fingerprint (an example of a detection target) of the finger. The NFC processing unit 151 executes the wireless communication processing (an example of second processing) by causing the alternating magnetic flux to be emitted from the NFC coil 20 (an example of a coil) connected to the NFC module 15 (an example of an electromagnetic coupling wireless module) and arranged close to the fingerprint sensor 161. Then, the NFC processing unit 151 controls the operation of the wireless communication processing according to the operating state of the fingerprint authentication processing. For example, the NFC processing unit 151 controls whether to emit the alternating magnetic flux from the NFC coil 20 according to the operating state of the fingerprint authentication processing.

Thus, even when the fingerprint sensor 161 and the NFC coil 20 are arranged close to each other, since the electronic device 10 can control not to be affected by the NFC coil 20 according to the operation of the fingerprint authentication processing by the FPR, malfunction (false detection) by the fingerprint sensor 161 cannot occur. Therefore, according to the embodiment, the NFC coil 20 and the fingerprint sensor 161 can be arranged close to each other while preventing malfunction.

Specifically, when the fingerprint authentication processing is started, the NFC processing unit 151 may control the alternating magnetic flux not to be emitted from the NFC coil 20. Then, after the NFC processing unit 151 controls the alternating magnetic flux not to be emitted from the NFC coil 20, the FPR processing unit 163 may start the fingerprint authentication processing.

Thus, since the alternating magnetic flux is not emitted from the NFC coil 20 during the operation of the fingerprint authentication processing by the FPR and the electronic device 10 is not affected, malfunction (false detection) by the fingerprint sensor 161 cannot occur. Therefore, according to the embodiment, the NFC coil 20 and the fingerprint sensor 161 can be arranged close to each other while preventing malfunction.

Further, the NFC processing unit 151 may also control to emit the alternating magnetic flux from the NFC coil 20 in response to the completion of the fingerprint authentication processing.

Thus, after the fingerprint authentication processing by the FPR is completed, the electronic device 10 can perform wireless communication by NFC.

In certain embodiments, an example of making a transition to wireless communication processing by NFC when the fingerprint authentication processing is not completed (for example, when the touch of the finger is not detected) for more than a predetermined time will be described.

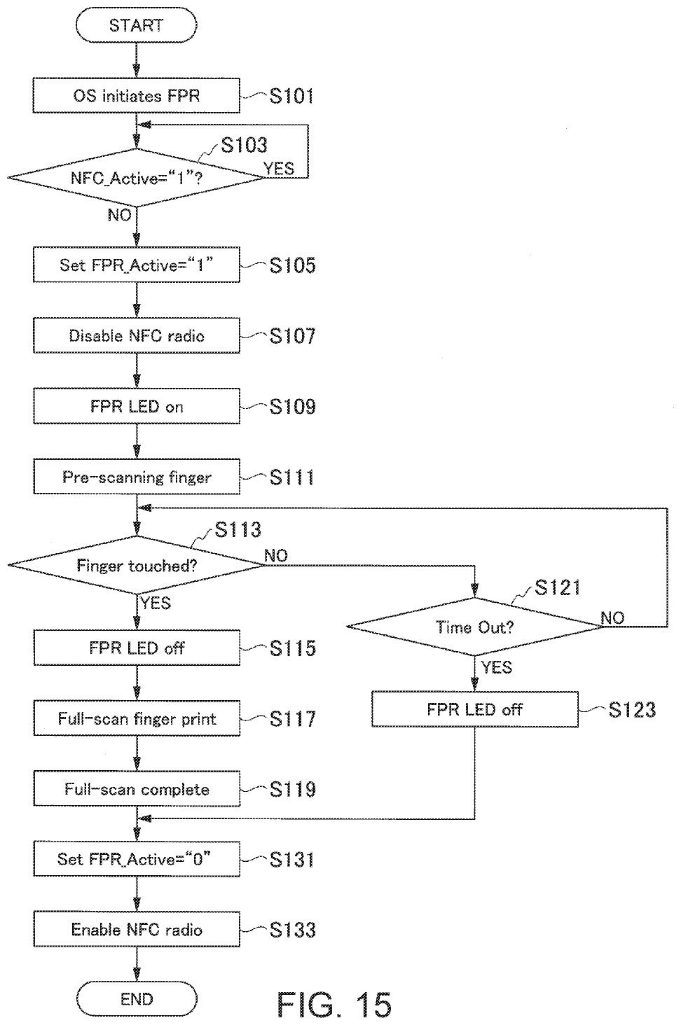

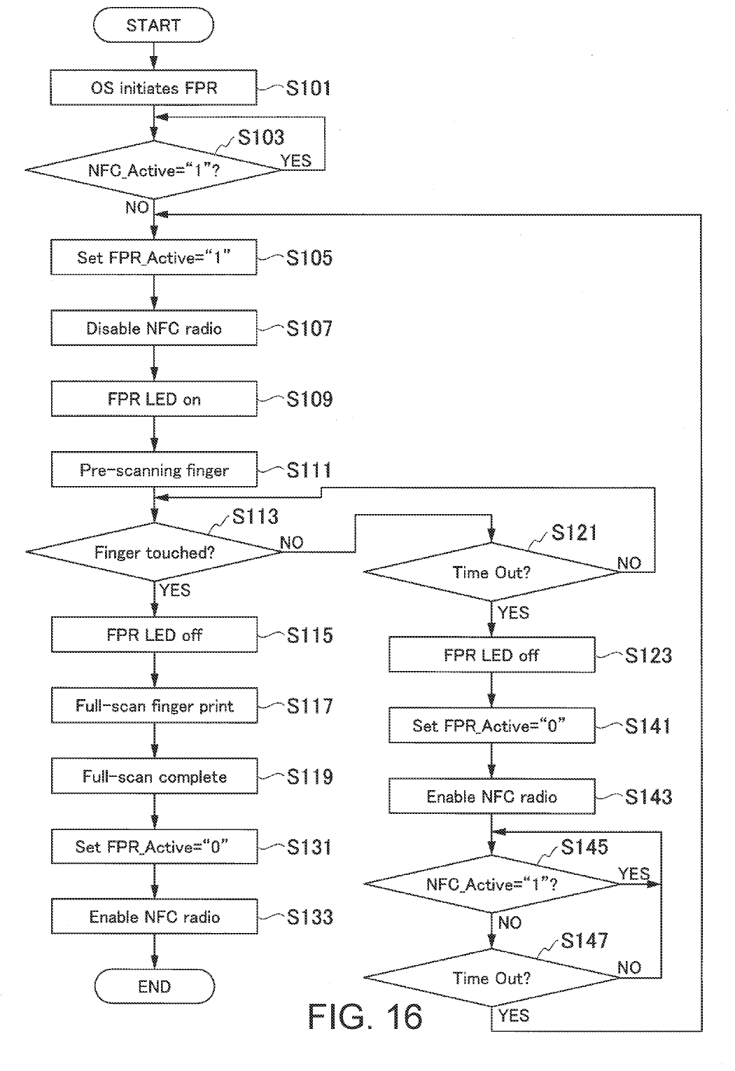

FIG. 15 is a flowchart illustrating processing in accordance with embodiments of the present disclosure. The processing illustrated in this figure is different from the processing illustrated in FIG. 14 in that step S121 and step S123 are added. Here, processing different from the processing in FIG. 14 will be described.

When the touch of the finger is not detected in step S113 (NO), the FPR processing unit 163 proceeds to processing in step S121 to determine whether a predetermined time or more has passed since the start of pre-scanning (Pre-scanning finger) or not (that is, whether it is timeout or not). When determining that the predetermined time or more has not passed yet (NO), the FPR processing unit 163 returns to processing in step S113. On the other hand, when determining that the predetermined time or more has passed (YES), the FPR processing unit 163 sets the FPR active signal (FPR_Active) to “0” (inactive) (step S131). In response to the fact that the FPR active signal (FPR_Active) is set to “0” (inactive), the NFC processing unit 151 controls “NFC_Radio” to be set to Enable so as to emit the alternating magnetic flux from the NFC coil 20 (step S133). Thus, the NFC processing unit 151 causes the alternating magnetic flux to be emitted from the NFC coil 20 intermittently. In other words, the NFC processing unit 151 starts wireless communication processing by NFC to detect the approach of the NFC card.

Thus, in the embodiment, the FPR processing unit 163 (an example of a first processing unit) stops the fingerprint authentication processing when the fingerprint authentication processing (the example of the first processing) is not completed for more than the predetermined time after being started. Then, when the fingerprint authentication processing is not completed for more than the predetermined time, the NFC processing unit 151 (the example of the second processing unit) controls the alternating magnetic flux to be emitted from the NFC coil 20 (the example of the coil).

Thus, even when wireless communication by NFC is temporarily disabled not to cause malfunction in the fingerprint authentication processing, the electronic device 10 can determine that the user does not intend to perform fingerprint authentication if the fingerprint authentication is not performed (for example, if the finger is not detected) for more than the predetermined time to switch to wireless communication by NFC effectively. For example, upon login authentication when the electronic device 10 is resumed, if both the fingerprint authentication and the NFC card authentication are supported, the fingerprint authentication will be first accepted preferentially. However, when the fingerprint authentication is not performed for more than the predetermined time, since the user is regarded as intending to use the NFC card authentication and hence switching to wireless communication by NFC is done automatically, it is convenient.

In certain embodiments, an example of returning to the fingerprint authentication again when the approach of the NFC card 50 is not detected for more than a predetermined time after the wireless communication by NFC is enabled will be described.

FIG. 16 is a flowchart illustrating an example of processing according to embodiments of the present disclosure. The processing illustrated in this figure is different from the processing illustrated in FIG. 15 in that steps S141, S143, S145, and S147 are added. Note, however, that steps S141 and S143 are the same as steps S131 and S133. Here, processing different from the processing illustrated in FIG. 15 will be described.

When determining that a predetermined time or more has passed since the start of pre-scanning (Pre-scanning finger) (YES in step S121), the FPR processing unit 163 sets the FPR active signal (FPR_Active) to “0” (inactive) (step S141). In response to the fact that the FPR active signal (FPR_Active) is set to “0” (inactive), the NFC processing unit 151 controls “NFC_Radio” to be set to Enable so as to emit the alternating magnetic flux from the NFC coil 20 (step S143). Thus, the NFC processing unit 151 causes the alternating magnetic flux to be emitted from the NFC coil 20 intermittently so as to start wireless communication processing by NFC.

Next, the FPR processing unit 163 determines whether the NFC active signal (NFC_Active) output from the NFC processing unit 151 is “1” (active) or not (step S145). When determining that the NFC active signal (NFC_Active) is “1” (active) (YES), the FPR processing unit 163 proceeds to processing in step S147, while when determining that the NFC active signal (NFC_Active) is “0” (inactive) (NO), the FPR processing unit 163 performs processing in step S145 again.

In step S147, the FPR processing unit 163 determines whether the predetermined time or more has passed since “NFC_Radio” was controlled to be set to Enable in step S143 or not (that is, whether it is timeout or not). When determining that the predetermined time or more has not passed yet (NO), the FPR processing unit 163 returns to processing in step S145. On the other hand, when determining that the predetermined time or more has passed (YES), the FPR processing unit 163 returns to processing in step S105 to set the FPR active signal (FPR_Active) to “1” (active). Thus, the NFC processing unit 151 controls “NFC_Radio” to be set to Disable so as not to emit the alternating magnetic flux from the NFC coil 20 (step S106). Then, the FPR processing unit 163 controls the LED 162 to be ON (FPR_LED ON =“1”) to light up (step S109) and starts pre-scanning (Pre-scanning finger) (step S111).

Note that the predetermined time (timeout time) used for the determination in step S121 and the predetermined time (timeout time) used for the determination in step S147 may be preset to be the same time or may be preset to be different times.

Thus, in the embodiment, the FPR processing unit 163 (the example of the first processing unit) and the NFC processing unit 151 (the example of the second processing unit) execute the fingerprint authentication processing (the example of the first processing) and the wireless communication processing (the example of the second processing) alternately for each timeout (an example of a predetermined condition), respectively.

Thus, for example, upon login authentication when the electronic device 10 is resumed, if both the fingerprint authentication and the NFC card authentication are supported, since processing will be automatically switched from one to the other alternately until either one of the authentications is established, it is convenient. When the predetermined time or more has passed without establishing either of the authentications, the control unit 14 may stop this automatically switching processing to continue either processing.

In the aforementioned embodiments, the examples in which the NFC processing unit 151 controls whether to emit the alternating magnetic flux from the NFC coil 20 according to the operating state of the fingerprint authentication processing are described, but the strength of the alternating magnetic flux emitted from the NFC coil 20 may be controlled. For example, instead of controlling the alternating magnetic flux not to be emitted from the NFC coil 20, the NFC processing unit 151 may reduce the alternating magnetic flux emitted from the NFC coil 20 to such a level as not to affect the fingerprint sensor 161.

Further, in the aforementioned embodiments, control in such a structure that the fingerprint sensor 161 and the NFC coil 20 are arranged close to each other is described, but the present disclosure may also be applied to such a structure that a capacitive sensor used in another processing instead of the fingerprint sensor 161 and the NFC coil 20 are arranged close to each other.

Note that the electronic device 10 described above has a computer system therein. Then, a program for implementing the function of each component included in the electronic device 10 described above may be recorded on a computer-readable recording medium so that the program recorded on this recording medium will be read into the computer system and executed to perform processing in each component included in the electronic device 10 described above. Here, the fact that “the program recorded on the recording medium is read into the computer system and executed” includes the fact that “the program is installed on the computer system.” Here, it is assumed that the “computer system” includes the OS and hardware such as a peripheral device and the like. Further, the “computer system” may also include two or more computers connected through a network including the Internet, WAN, LAN, and a communication line such as a dedicated line. Further, the “computer-readable recording medium” means a storage medium such as a flexible disk, a magneto-optical disk, a ROM, a portable medium like a CD-ROM, or a hard disk incorporated in the computer system. The recording medium with the program stored thereon may be a non-transitory recording medium such as the CD-ROM.

A recording medium internally or externally provided to be accessible from a delivery server for delivering the program is included as the recording medium. Note that the program may be divided into plural pieces, downloaded at different timings, respectively, and then united in each component included in the electronic device 10, or delivery servers for delivering respective divided pieces of the program may be different from one another. Further, the “computer-readable recording medium” includes a medium on which the program is held for a given length of time, such as a volatile memory (RAM) inside a computer system as a server or a client when the program is transmitted through the network. The above-mentioned program may also be to implement some of the functions described above. Further, the program may be a so-called differential file (differential program) capable of implementing the above-described functions in combination with a program(s) already recorded in the computer system.

Further, some or all of the functions of the electronic device 10 in the above-described embodiments may be realized as an integrated circuit such as LSI (Large Scale Integration). Each function may be a processor implemented individually, or part or whole thereof may be integrated as a processor. Further, the method of circuit integration is not limited to LSI, and it may be realized by a dedicated circuit or a general-purpose processor. Further, if integrated circuit technology replacing the LSI appears with the progress of semiconductor technology, an integrated circuit according to the technology may be used.

Further, in the aforementioned embodiments, the example in which the electronic device 10 is the laptop PC is described, but the present disclosure is not limited thereto, and can also be applied to various electronic devices such as a cell-phone like a smartphone, a tablet PC, a desktop PC, a game machine, and the like.

While the embodiments of this disclosure have been described in detail with reference to the accompanying drawings, the specific configuration is not limited to that described above, and various design changes are possible without departing from the scope of this disclosure.

What is claimed is:

1. An electronic device comprising:
a first processing unit configured to execute first processing for detecting a detection target based on an output signal of a capacitive sensor; and
a second processing unit configured to execute second processing using radio by causing an alternating magnetic flux to be emitted from a coil connected to an electromagnetic coupling wireless module and arranged close to the capacitive sensor, wherein the second processing unit controls operation of the second processing according to an operating state of the first processing.

2. The electronic device of claim 1, wherein the second processing unit controls whether to emit the alternating magnetic flux from the coil according to the operating state of the first processing.

3. The electronic device of claim 2, wherein the second processing unit controls the alternating magnetic flux to be emitted from the coil in response to completion of the first processing.

4. The electronic device of claim 3, wherein:
the second processing unit controls the alternating magnetic flux not to be emitted from the coil when the first processing is started; and
the first processing unit starts the first processing after the second processing unit controls the alternating magnetic flux not to be emitted from the coil.

5. The electronic device of claim 4, wherein:
the first processing unit stops the first processing when the started first processing is not completed for more than a predetermined time; and
the second processing unit controls the alternating magnetic flux to be emitted from the coil when the first processing is not completed for more than the predetermined time.

6. The electronic device of claim 5, wherein the first processing unit and the second processing unit execute the first processing and the second processing alternately under a predetermined condition.

7. The electronic device of claim 1, wherein:
the capacitive sensor is a fingerprint sensor for detecting a fingerprint; and
the first processing unit performs fingerprint authentication by detecting the fingerprint based on an output signal of the fingerprint sensor.

8. The electronic device of claim 1, further comprising:
the capacitive sensor; and
the coil, wherein the capacitive sensor and the coil are arranged in positions corresponding to an opening without being covered with metal in a chassis of the electronic device.

9. An electronic component comprising:
a capacitive sensor; and
a coil connected to an electromagnetic coupling wireless module and arranged close to the capacitive sensor.

10. The electronic component of claim 9, wherein the capacitive sensor and the coil are overlapped with each other.

11. The electronic component of claim 10, wherein the coil is arranged to surround the capacitive sensor.

12. A method comprising:
executing first processing, by a first processing unit, for detecting a detection target based on an output signal of a capacitive sensor; and
executing second processing, by a second processing unit, using radio by causing an alternating magnetic flux to be emitted from a coil connected to an electromagnetic coupling wireless module and arranged close to the capacitive sensor, wherein operation of the second processing is controlled according to an operating state of the first processing.

13. The method of claim 12, wherein the second processing unit controls whether to emit the alternating magnetic flux from the coil according to the operating state of the first processing.

14. The method of claim 13, wherein the second processing unit controls the alternating magnetic flux to be emitted from the coil in response to completion of the first processing.

15. The method of claim 14, further comprising controlling the alternating magnetic flux not to be emitted from the coil when the first processing is started.

16. The method of claim 15, further comprising starting the first processing after the second processing unit controls the alternating magnetic flux not to be emitted from the coil.

17. The method of claim 16, further comprising:
stopping the first processing when the started first processing is not completed for more than a predetermined time; and
controlling the alternating magnetic flux to be emitted from the coil when the first processing is not completed for more than the predetermined time.

18. The method of claim 17, further comprising executing the first processing and the second processing alternately under a predetermined condition.

19. The method of claim 12, wherein the capacitive sensor is a fingerprint sensor for detecting a fingerprint.

20. The method of claim 19, wherein the first processing unit performs fingerprint authentication by detecting the fingerprint based on an output signal of the fingerprint sensor.
